(19) United States
(12) Patent Application Publication
(10) Pub. No.: US 2017/0329972 A1
(43) Pub. Date: Nov. 16, 2017

(54) DETERMINING A THREAT SEVERITY ASSOCIATED WITH AN EVENT

(71) Applicant: QUEST SOFTWARE INC., Aliso Viejo, CA (US)

(72) Inventors: Michel Albert Brisebois, Renfrew (CA); Curtis Johnstone, Ottawa (CA)

(21) Appl. No.: 15/150,592

(22) Filed: May 10, 2016

(51) Int. Cl. G06F 21/57; G06F 21/62

(52) U.S. Cl. CPC G06F 21/577; G06F 21/6218

(57) ABSTRACT

Systems and techniques for assessing a risk associated with a data loss prevention (DLP) policy violation are described. Characteristics of data associated with the DLP policy violation and user information associated with a participant associated with the DLP policy violation may be determined. An expertise and a position of the participant may be determined and correlated with the one or more characteristics of the data to determine a risk assessment associated with the DLP policy violation. After determining that the risk assessment satisfies a threshold, a subject matter expert may be determined based on the characteristics of the data, and an alert may be sent to the subject matter expert requesting review of the DLP policy violation.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An enterprise security threat detection system may trigger an event log after detecting the occurrence of an activity that transgresses a specific policy. For example, a policy may be specified in terms of a set of rules. When the set of rules is satisfied, the threat detection system may generate an event log. For example, the threat detection system may create an event log in response to scanning contents of an email and identifying a number that matches a credit card number. A system administrator may manually review the event log to determine a threat level of the event. For example, the administrator may review the event log and determine that the number in the email is not a credit card number and therefore does not pose a risk of data loss. The enterprise security threat detection system may trigger an event log (e.g., a data loss prevention (DLP) log) after detecting the occurrence of an activity that may potentially involve data loss, such as a change in user credentials or an administrator credentials. For example, changes to passwords, changes to credentials, changes to access rights or admin privileges, etc. may potentially be a threat, but must be manually examined by a human to determine whether there is an actual threat and how much of a threat they may pose.

Thus, assessing a risk associated with a DLP event log may be a manual process that focuses on (i) the data involved in the DLP event, (ii) actions associated with the data, and (iii) access to the data. However, while a user may have performed an action that triggered a DLP event log to be generated, the characteristics of the user involved in the DLP event may not be factored into the assessment of risk.

### SUMMARY

This Summary provides a simplified form of concepts that are further described below in the Detailed Description. This Summary is not intended to identify key or essential features and should therefore not be used for determining or limiting the scope of the claimed subject matter.

Systems and techniques for assessing a risk associated with a data loss prevention (DLP) policy violation are described. Characteristics of data associated with the DLP policy violation and user information associated with a participant associated with the DLP policy violation may be determined. An expertise and a position of the participant may be determined and correlated with the one or more characteristics of the data to determine a risk assessment associated with the DLP policy violation. After determining that the risk assessment satisfies a threshold, a subject matter expert may be determined based on the characteristics of the data, and an alert may be sent to the subject matter expert requesting review of the DLP policy violation.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram of an architecture that includes a risk assessment engine according to some embodiments.

FIG. 2 is a block diagram of an architecture that includes a subject matter expert (SME) system according to some embodiments.

FIG. 3 is a block diagram of an architecture that includes a data loss prevention (DLP) system according to some embodiments.

FIG. 4 is a flowchart of a process that includes determining that a risk assessment satisfies a threshold according to some embodiments.

FIG. 5 illustrates an exemplary process to build and train a classifier according to some embodiments.

FIG. 6 illustrates an example configuration of a computing device that may be used to implement the systems and techniques described herein.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or video display. The information handling system may also include one or more buses operable to transmit communications between the various hardware components.

The system and techniques described herein may automatically perform a risk assessment associated with a DLP event (e.g., generated by a DLP system) based in part on the expertise of a user that caused the event. For example, a risk assessment engine may use an expertise profile created by a subject matter expert (SME) system to determine an amount of risk associated with the DLP event.

The SME system may automatically (e.g., without human interaction) create an employee profile that includes each employee's areas of expertise. For example, the SME system may use crawlers to crawl (a) internal (e.g., enterprise) data sources, such as communication systems, such as Microsoft® Exchange®, Lync®/Skype®, Office365®, phone systems (e.g., using voice over internet protocol (VoIP)), human resources systems, enterprise resource planning (ERP) systems, customer relationship management (CRM) systems, etc. and (b) external data sources, such as papers published at conferences, papers published by professional organizations (e.g., Institute of Electrical and Electronic Engineers (IEEE), Association for Computing Machinery (ACM), etc.), patent applications in patent databases (e.g., www.uspto.gov, www.epo.org, etc.), social networking sites (e.g., LinkedIn®), etc.

A DLP system may monitor communications (e.g., emails, conferencing, messaging, etc.) in the enterprise and automatically generate a DLP event log when a potential DLP event is detected. A risk assessment engine may automatically (e.g., without human interaction) determine a risk associated with the DLP event by taking into consideration (i) the characteristics of the user involved in the DLP event in addition to the (ii) data (e.g., a credit card number) associated with the DLP event, (iii) one or more action(s) associated with the data (e.g., an email that includes a credit card number was sent to an external computer), and (iv) access to the data (e.g., a user's credentials were changed to access credit card information in a file). For example, a user may email a large file from a corporate computer to an external address, causing the DLP system to determine that a potential DLP event occurred and to generate a DLP event log. The risk assessment engine may determine that the file includes information associated with a company's e-commerce strategy. The risk assessment engine may access a user profile created by the SME system to determine that the user is a subject matter expert in e-commerce strategy. Based on determining the content of the file and determining the user's expertise, the risk assessment engine may assign a high risk of data loss to the DLP event. In contrast, in a conventional system, an administrator investigating the threat severity of a DLP event is unlikely to know the context around the DLP event, such as the expertise of a user associated with the DLP event.

The risk assessment engine may correlate (i) the SME profile of a user associated with a DLP event with (ii) the data involved in the DLP event to create a risk assessment associated with the DLP event. The risk assessment engine may generate an alert when the risk assessment of a DLP event is higher than a predetermined threshold. A SME system may use internal (e.g., enterprise-based) data sources and external data sources to generate a SME profile for each employee in an enterprise. The DLP system may monitor enterprise-based communications (e.g., email, voicemail, instant messages, voice calls, conference calls, etc.) and may generate an event log in response to determining that one or more security policies have been transgressed.

For DLP event logs determined as high risk, the risk assessment engine may create and send an alert to an administrator to review the potential threat. For example, a DLP system may include multiple security policies. Each security policy may be defined using one or more rules. When the rules of a security policy are satisfied (e.g., indicating that a policy violation has occurred), a DLP event log may be generated and sent to the risk assessment engine. The risk assessment engine may parse the DLP event log to determine (i) user information to identify one or more users associated with the DLP event log and (ii) identify the data associated with the DLP event. The risk assessment engine may send the user information to the SME system for analysis. For each user associated with the DLP event, the SME system may provide a SME assessment that includes the extent of the user's knowledge in various areas, the depth knowledge in each area, the breadth of knowledge in each area, the extent to which the user has collaborated with others in each area, and the user's rank or position in the organization (e.g., based on information from a directory system, such as Active Directory®). In some cases, the SME system may determine the user's access rights from an identity and access management system, such as Dell® Access Identity Manager. The SME system may analyze data associated with the DLP event to determine characteristics of the data. The data associated with the DLP event may include contents of a body of an email, email attachments, instant messages, transcriptions of voice calls or video calls, contents of document repositories (e.g., SharePoint® sites), or the like.

Machine learning based on Bayesian reasoning may be used to derive an inference of risk. In Bayesian reasoning, to evaluate the probability of a hypothesis, a prior probability is initially assigned to the hypothesis. The prior probability may later be updated to a posterior probability in light of new, relevant data. For example, a machine learning algorithm, such as a classifier, may be used to analyze an event log (e.g., based on Bayesian probabilities) to determine a risk associated with the event that caused the event log. The risk assessment engine may determine a risk assessment and send the risk assessment to the DLP system to perform triage (e.g., classification and assessment) of the DLP event with the revised threat assessment.

The risk assessment engine may identify an appropriate expert to review the DLP event to determine the severity of the breach. For example, the risk assessment engine may (1) identify one or more SMEs to review the event log, (2) send an alert to the one or more SMEs to review the DLP event, (3) send data associated with the DLP event, and (4) provide a mechanism to enable the SMEs to indicate whether to escalate or ignore the DLP event. By identifying experts associated with the type of DLP event that occurred, a more accurate assessment of the data loss threats may be performed as compared to merely having a system administrator perform the risk assessment.

Thus, when a potential DLP event occurs, a DLP system may create a DLP event log. The DLP event log may be processed by a risk assessment engine. For example, the risk assessment engine may correlate the characteristics of the data involved in the DLP event with the expertise associated with one or more users (e.g., sending user, receiving user, etc.) involved in the DLP event to determine an initial risk assessment. If the initial risk assessment satisfies a threshold, the risk assessment engine may use the SME system to identify one or more SMEs and send data associated with the DLP event to the SMEs for further assessment. Because the risk assessment engine performs an automated risk assessment before sending an alert to the SMEs, the SMEs may receive fewer alerts. In addition, the DLP event that the SMEs are asked to review is more likely to involve a threat. Further, the SMEs are more likely to be able to make an accurate risk assessment of the DLP event because of their expertise.

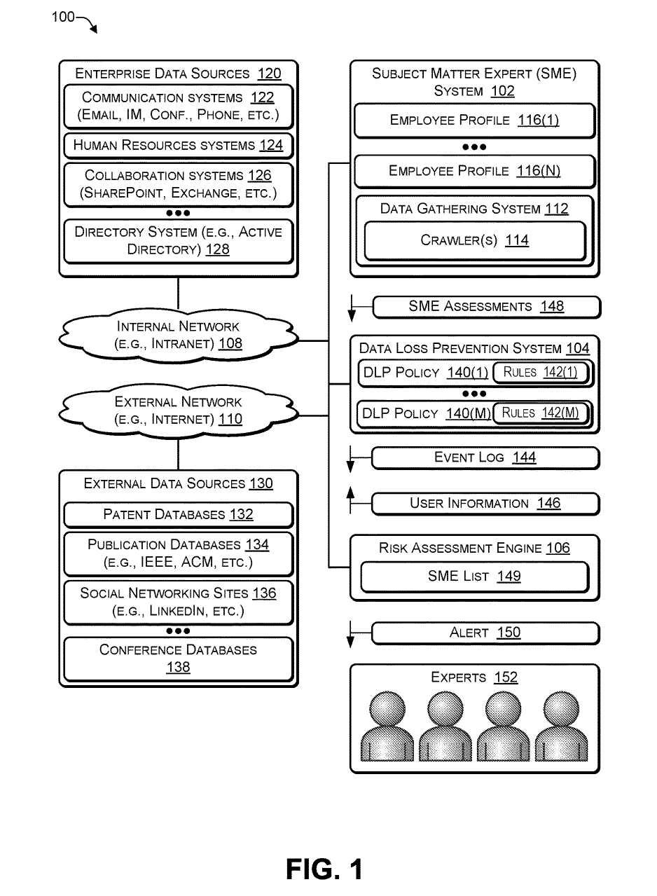

FIG. 1 is a block diagram of an architecture 100 that includes a risk assessment engine according to some embodiments. A subject matter expert (SME) system 102, a data loss prevention (DLP) engine 104, and a risk assessment engine 106 may be coupled to an internal network 108 (e.g., an intranet) of an enterprise. At least one of the SME system 102, the DLP engine 104, or the risk assessment engine 106 may be coupled to an external network 110 (e.g., the internet), e.g., a network that is external to the enterprise.

The SME system 102 may use a data gathering system 112 that includes one or more web crawlers 114 to retrieve data from the internal network 108, the external network 110, or both. The data gathered by the SME system 102 may be used to populate master employee profiles, e.g., such as an employee profile 116(1) to an employee profile 116(N) (where N>1). Each of the employee profiles 116 may include user contributed data, organizational data, and expertise data. The user contributed data may include information, such as personal information (e.g., hobbies, interests, etc.) provided by the employee that is associated with a particular employee profile. The organizational data may include organizational information gathered by the SME system 102 via the internal network 108, such as a current position (e.g., software architect) in the organization, zero or more people (e.g., subordinates) who report to the employee, zero or more people in the same group (e.g., peers) as the employee, and one or more people to whom the employee reports (e.g., the employee's supervisor or manager). The organizational data may include past (e.g., historical) data, such as projects that the employee previously worked on, previous positions, previous subordinates, previous managers, etc.

The expertise data in each employee profile 116 may include expertise information gathered from enterprise data sources 120, including information gathered from corporate communication systems 122, human resources systems 124, collaboration systems 126, a directory system (e.g., Active Directory) 128, other corporate systems (e.g., CRM, etc.), or any combination thereof The communications systems 122 may include email applications (e.g., Outlook®, Lotus® Notes, etc.), instant messaging services (e.g., Microsoft® Messenger etc.), audio and/or video conferencing (e.g., Skype® etc.), phone systems (e.g., using Voice over IP (VoIP) or other technologies), other types of communications systems, or any combination thereof. Data may be extracted from the communications systems 122 using a software product, such as Dell® Unified Communications Command Suite (UCCS), that monitors and archives corporate communications and is capable of extracting data from the corporate communications. The human resources systems 124 may include Human Resources Management Systems (HRMS) (also known as Human Resources Information Systems (HRIS)) that include software functionality to manage payroll, recruitment, storing and providing access to employee information, keeping attendance records and tracking absenteeism, performance evaluations, benefits administrations, training management, employee self-service, employee scheduling, etc. The collaboration systems 126 may include systems used to facilitate the efficient sharing of documents and knowledge between teams and individuals in an enterprise (e.g., Microsoft® Exchange, SharePoint® etc.). Employee emails, instant messages, and other corporate communications may be analyzed (e.g., using a machine learning algorithm such as classifier) to determine an expertise of each employee. For example, a particular employee may have an expertise in machine learning algorithms. Other employees may send questions in communications, such as emails, instant messages, etc. to the particular employee. The particular employee may respond to the questions by sharing his expertise in machine learning. By analyzing the employee's communications, the employee's breadth and depth of expertise may be determined. For example, the depth of expertise may be determined based on how many words are included in the employee's responses, e.g., a relatively few number of words may indicate a relatively shallow depth of knowledge while a larger number of words may indicate greater depth of knowledge. The breadth of expertise may be determined based on how many different questions in the area of machine learning to which the employee responds. For example, if the particular employee receives five questions in different areas of machine learning, and three of the answers have a relatively few number of words but two of the answers, both of which are in related areas, have a larger number of words, then the particular employee may not have a very broad expertise in the topic of machine learning. In contrast, if the particular employee receives the five questions, and all five responses have a larger number of words, then the particular employee may have relatively broad knowledge in the topic of machine learning. Similar to how corporate communications are analyzed, internal documents (e.g., Word®, PowerPoint®, etc.) produced by the employee and stored in a document database (e.g., ShaePoint®) may be analyzed to determine the employee's expertise, including breadth of expertise and depth of expertise.

The expertise data may include expertise information gathered from external data sources 130, such as, for example, patent databases 132 (e.g., provided by the United States Patent and Trademark Office (USPTO), the European Patent Office (EPO), etc.), publication databases 134 that include technical papers (e.g., published by organizations such as the Institute of Electrical and Electronic Engineers (IEEE), Association for Computing Machinery (ACM), etc.), social networking sites 136 (e.g., LinkedIn®, etc.), and conference databases 138 that include papers presented at conferences. Patent applications, technical papers, and other documents may be analyzed using a classifier or other machine learning algorithm to determine each employee's area of expertise, the employee's depth of expertise, the employee's breadth of expertise, etc.

At least some of the data included in the master employee profiles 116 may feed back into the enterprise data sources 120. For example, the master employee profiles 116 may feed into the human resources systems 124 to provide a view of each employee's skill set that includes information extracted from the external data sources 130. In this way, employee development, training, compensation, etc. may be based on a comprehensive skill set profile of each employee.

The DLP system 104 may include one or more DLP policies, such as a DLP policy 140(1) to a DLP policy 140(M) (M>1). Each of the DLP policies 140 may include one or more rules. For example, the DLP policy 140(1) may include one or more rules 142(1) and the DLP policy 140(M) may include one or more rules 142(M). The DLP system 104 may monitor the enterprise data sources 120 that are accessible via the internal network 108. When the DLP system 104 detects the occurrence of an event, the DLP system 104 may determine whether the event satisfies one of the rules 142 (e.g., whether the event is a DLP event). If the event satisfies one of the rules 142 (e.g., indicating a violation of one of the DLP policies 140), then the DLP system 104 may generate a log, such as an event log 144.

The DLP system 104 may monitor the enterprise data sources 120 (e.g., email messages, attachments, audio/video conferencing, etc.) and perform content analysis of the communications. For example, the DLP system 104 may use keyword matches, dictionary matches, regular expression evaluation, or other techniques to perform content analysis to determine whether the event log 144 is associated with content that violates the DLP policies 140. The content analysis may be used to identify and monitor many categories of sensitive information, such as private identification numbers (e.g., social security number, employee number, birthday, etc.), credit card numbers, information that is confidential or sensitive to the enterprise, and the like. Examples of confidential or sensitive information may include financial data or personally identifiable information (PII) (e.g., credit card numbers, social security numbers, health records, etc.). For example, the DLP system 104 may determine that an event occurred in which a document that included sensitive information was shared with people outside the enterprise. Based on the determination, the DLP system 104 may generate the event log 144. The DLP policies 140 may include policies to comply with regulatory standards, such as the Gramm-Leach-Bliley Act (GLBA), the Payment Card Industry Data Security Standard (PCI-DSS), the United States Personally Identifiable Information (U.S. PII), or the like.

### Assessing Risk Based on the Expertise Of Participants

When an event causes the event log 144 to be generated by the DLP system 104, the risk assessment engine 106 may analyze the event log 144 to determine a risk associated with the event. The risk assessment engine 106 may parse the event log 144 to determine information, such as (a) one or more users associated with the event and (b) data associated with the event. For example, when restricted or sensitive data is sent from the enterprise to an external location using one of the communications systems 122, the risk assessment engine 106 may parse the event log 144 to determine user information 146, such as the sender of the data and one or more recipients of the data. The risk assessment engine 106 may send the user information 146 to the SME system 102 for analysis.

For each participant (e.g., sender or recipient) associated with the event, the SME system 102 may provide a SME assessment. For example, in response to receiving the user information 146, the SME system 102 may provide SME assessments 148. The SME assessments 148 may include an assessment of the expertise of each user (e.g., participant) involved in the event, such as, for example, an extent of the user's knowledge in various areas, the depth and breadth of that knowledge, the extent of the user's collaboration with others in regards to the knowledge area, the user's organization rank (e.g., for enterprise employees, the rank may be determined via Active Directory data), the user's organization, position, level, manager, etc. The SME assessments 148 may include access rights (e.g., read-write privileges) associated with each user involved in the event.

The risk assessment engine 106 may analyze the characteristics of the data involved in the event, such as whether the data is confidential, protected, restricted, sensitive, etc. The risk assessment engine 106 may analyze data involved in the event, including contents of (i) emails, (ii) attachments, (iii) instant messages (e.g., electronic chats), (iv) transcribed voice or video calls, (v) contents of data stores (e.g., SharePoint® etc.), and other data related to the event. The risk assessment engine 106 may use machine learning techniques, such as support vector machines, Bayesian networks, or the like to analyze the data involved in the event to determine a risk associated with the event log 144.

The risk assessment engine 106 may assign a risk value from a range of values to the event log 144. For example, the range of values may include specific values (e.g., low risk, medium risk, and high risk), a numeric value from 1 to X (e.g., X=10, X=100, or the like) where a larger number represents a greater risk and a smaller number represents a lesser risk, or another type of value representing the risk.

### Identifying Experts to Confirm the Risk Assessment

The risk assessment engine 106 may identify one or more experts to further assess the risk associated with the event associated with the event log 144. For example, the risk assessment engine 106 may, before the event log 144 is generated, identify employees of the enterprise that are subject matter experts (SMEs) in various topics and store a SME list 149 that includes the names of SMEs, their respective topics of expertise, contact information, etc. When the risk assessment engine 106 determines that a risk associated with the event log 144 satisfies a threshold (e.g., risk assessment is high, or 8/10 or greater, or 80/100 or greater), then the risk assessment engine 106 may determine a subject matter of the event log 144 and match the subject matter with one or more expects selected from the SME list 149. The risk assessment engine 106 may send an alert 150 to one or more experts 152 selected from the SME list 149. The alert 150 may include data from the event log 144, the user information 146, and the SME assessments 148. The experts 152 may analyze the data included in the alert 150 and determine whether to escalate or de-emphasize the event associated with the event log 144. For example, the experts 152 may analyze the event log 144, the user information 146, and the SME assessments 148, determine that a vice president of marketing sent a marketing plan to a competitor, and escalate the event because the event involves the loss of confidential or restricted data. As another example, the experts 152 may analyze the event log 144, the user information 146, and the SME assessments 148, determine that the vice president of marketing sent a photo of the vice president receiving an award to his wife, and de-emphasize (e.g., indicate that the possibility of data loss is unlikely) the event.

Thus, the risk assessment engine 106 may perform two main functions. First, the risk assessment engine 106 may correlate the expertise of participants in an event with the event itself to perform an initial risk assessment of the event. For example, if an expert in a particular subject matter (e.g., a particular technical area, marketing, sales, etc.) sends a document associated with the particular subject matter then the risk assessment engine 106 may assign a high risk value to the event. Second, for events that have been assigned a risk value that satisfies a threshold (e.g., high risk value), the risk assessment engine 106 may send an alert to one or more experts in the particular subject matter. By correlating the expertise of participants in an event with the event itself, the initial risk assessment of the event may be more accurate as compared to merely looking at the details of the event itself. Thus, the experts 152 may receive fewer alerts to review because of the correlating.

Thus, when a security violation occurs (e.g., a data loss prevention policy has been violated) the risk assessment engine determines a context associated with the violation, such as who is involved, what each participant typical does historically, what is each participant's expertise, etc. The event log generated by the DLP policy by itself does not provide any context for determining how much risk is involved, how quickly the violation should be dealt with, whether any actions should be taken, etc. In addition, an information technology (IT) administrator that receives a notification of a DLP event may lack the knowledge to evaluate the data involved in the DLP event when determining the risk associated with the DLP event. By matching the particular DLP policy that was violated with the subject matter expert list, the DLP event can be evaluated by an expert to determine the level of the threat. For example, a salesperson may send some documents after hours to an external domain that is classified as a competitor, causing a DLP policy violation. The document may be picture of the salesperson receiving an award at a company event and the domain that is classified as a competitor may be where his wife works. When analyzing the salesperson's behavior, factors that may be taken into consideration may include how often the salesperson is in contact with the particular domain, is the communication sent during normal business hours or after hours, is the communication outside a “normal” behavior range, etc. In addition, the document that was sent may be analyzed. Information about the user's position etc. may be determined using Active Directory and taken into account when assessing the risk of the DLP policy violation.

When a DLP policy violation is detected, the risk assessment system determines (i) a context associated with participants (e.g., particularly the sender) that triggered the DLP policy violation and (ii) the identities of experts that know something about the topic of the data or the event that triggered the DLP policy violation.

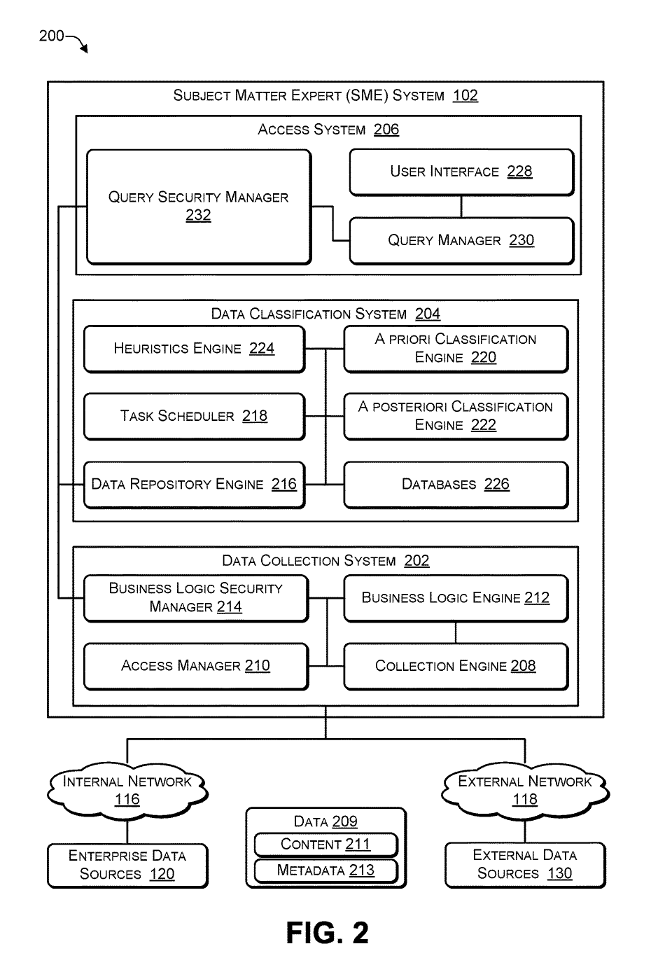

FIG. 2 is a block diagram of an architecture 200 that includes a data gathering system according to some embodiments. The SME system 102 may include a data collection system 202, a data classification system 204, and an access system 206.

The data collection system 202 may collect data from the enterprise data sources 120, the external data sources 130, or both. The data collection system 202 may include a collection engine 208, an access manager 210, a business logic engine 212, and a business logic security manager 214.

The collection engine 208 may access the enterprise data sources 120 to access data (e.g., data 209) that is stored by or generated by the enterprise data sources 120. This data may include data (e.g., emails, voicemails, instant messages, documents, etc.) that may be created, accessed, or received by a user or in response to the actions of a user in the enterprise. The collection engine 208 may access data (e.g., the data 209) from the external data sources 130. In some cases, the data 209 gathered from one of the resources 120, 130 may include content 211 and metadata 213. For example, when the collection engine 208 accesses a file server, the data 209 may include the metadata 213 associated with the files stored on the file server, such as the file name, file author, file owner, time created, last time edited, etc.

In some cases, at least one data source of the enterprise data sources 120 or the external data sources 130 may provide the data collection system 202 with access to data after the data collection system 202 has been authenticated. Authentication may be required for a number of reasons. For example, the data source may provide individual accounts to users, such as a social networking account, an email account, or a collaboration system account. As another example, the data source may provide different features based on the authorization level of a user. For example, a billing system may be configured to allow all employees of an organization to view invoices, but to only allow employees of the accounting department to modify invoices.

For data sources that require authentication, the access manager 210 may facilitate access by managing credentials for accessing the data sources. For example, the access manager 210 may store and manage user names, passwords, account identifiers, certificates, tokens, and other access related credentials used to access accounts associated with one or more of the enterprise data sources 120, or the external data sources 130. For instance, the access manager 210 may have access to credentials associated with a business's Facebook™ or Twitter™ account. As another example, the access manager 210 may have access to credentials associated with an LDAP directory, a file management system, or employee work email accounts.

In some embodiments, the access manager 210 may have credentials or authentication information associated with an administrative account or super user account to enable access to all of the user accounts, e.g., without requiring credentials or authentication information associated with individual user accounts. The collection engine 208 may use the access manager 210 to access the data sources 120, 130.

The business logic engine 212 may include algorithms to modify or transform the data 209 collected by the collection engine 208 into a standardized format. In some embodiments, the standardized format may be based on the data source accessed and/or the type of data accessed. For example, the business logic engine 212 may use a first format for data associated with emails, a second format for data associated with documents (e.g., Word®, PowerPoint®, Excel® etc.), a third format for data associated with web pages, and so on. Each type of data may be formatted consistently, e.g., data associated with product design files may be transformed into a common format even when the product design files are of different types. As another example, suppose that the business logic engine 212 is configured to record time using a 24-hour clock format. If one email application records the time an email was sent using a 24-hour clock format, and a second email application uses a 12-hour clock format, the business logic engine 212 may reformat the data from the second email application to use a 24-hour clock format.

In some embodiments, a user may define the format for processing and storing different types of data. In other embodiments, the business logic engine 212 may identify a standard format to use for each type of data based on, for example, the format that is most common among similar types of data sources, the format that reduces the size of the information, etc. The business logic security manager 214 may implement security and data access policies for data accessed by the collection engine 208. In some cases, the business logic security manager 214 may apply the security and data access policies to data before the data is collected as part of a determination as to whether to collect particular data. For example, an organization may designate a private folder or directory for each employee and the data access policies may include a policy to not access any files or data stored in the private directory. In some cases, the business logic security manager 214 may apply the security and data access policies to data after it is collected by the collection engine 208. Further, in some cases, the business logic security manager 214 may apply the security and data access policies to the abstracted and/or reformatted data produced by the business logic engine 212. For example, suppose the organization associated with the SME system 102 has adopted a policy of not collecting emails designated as personal. In this example, the business logic security manager 214 may examine email to determine whether it is addressed to an email address designated as personal (e.g., email addressed to family members) and if the email is identified as personal, the email may be discarded by the data collection system 202 or not processed any further by the SME system 102.

In some embodiments, the business logic security manager 214 may apply a set of security and data access policies to data or metadata provided to the data classification system 204 for processing and storage. These security and data access policies may include any policy for regulating the storage and access of data obtained or generated by the data collection system 202. For example, the security and data access policies may identify the users who may access the data provided to the data classification system 204. The determination as to which users may access the data may be based on the type of data. The business logic security manager 214 may tag the data with an identity of the users, or a class or a role of users (e.g., mid-level managers and more senior) who may access the data. As another example, of a security and data access policy, the business logic security manager 214 may determine how long the data may be stored by the data classification system 204 based on, for example, the type of data or the source of the data.

After the data collection system 202 has collected and, in some cases, processed the data 209 obtained from the enterprise data sources 120 and/or the external data sources 130, the data 209 may be provided to the data classification system 204 for further processing and storage. The data classification system 204 may include a data repository engine 216, a task scheduler 218, an a priori classification engine 220, an a posteriori classification engine 222, a heuristics engine 224 and a set of one or more databases 226.

The data repository engine 216 may index the data 209 received from the data collection system 202. The data repository engine 216 may store the data 209, including the associated index, in the set of databases 226. In some cases, the set of databases 226 may store the data 209 in a particular database of the databases 226 based on factors such as, for example, the type of the data 209, the source of the data 209, or the security level or authorization class associated with the data 209, the class of users who may access the data 209, another characteristic of the data 209, or any combination thereof

The set of databases 226 may be dynamically expanded and, in some cases, the set of databases 226 may be dynamically structured. For example, if the data repository engine 216 receives a new type of data that includes metadata fields not supported by the existing databases of the set of databases 226, the data repository engine 216 may create and initialize a new database that includes the metadata fields as part of the set of databases 226. For instance, suppose the organization associated with the SME system 102 creates a first social media account for the organization to expand its marketing initiatives. Although the databases 226 may have fields for customer information and vendor information, it may not have a field identifying whether a customer or vendor has indicated that they “like” or “follow” the organization on its social media page. The data repository engine 216 may create a new field in the databases 226 to store this information and/or create a new database to capture information extracted from the social media account including information that relates to the organization's customers and vendors.

The data repository engine 216 may create abstractions of and/or classify the data received from the data collection system 202 using, for example, the task scheduler 218, the a priori classification engine 220, the a posteriori classification engine 222, and the heuristics engine 224. The task scheduler 218 may manage the abstraction and classification of the data received from the data collection system 202. In some embodiments, the task scheduler 218 may be included as part of the data repository engine 216.

Data that is to be classified and/or abstracted may be supplied to the task scheduler 218. The task scheduler 218 may supply the data to the a priori classification engine 220 to classify data based on a set of user-defined, predefined, or predetermined classifications. These classifications may be provided by a user (e.g., an administrator) or may be provided by the developer of the SME system 102. In some cases, the predetermined classifications may include objective classifications that may be determined based on attributes associated with the data. For example, the a priori classification engine 220 may classify communications based on whether the communication is an email, an instant message, or a voice mail. As a second example, files may be classified based on the file type, such as whether the file is a drawing file (e.g., an AutoCAD™ file), a presentation file (e.g., a PowerPoint™ file), a spreadsheet (e.g., an Excel™ file), a word processing file (e.g., a Word™ file), etc. The a priori classification engine 220 may classify data at substantially near the time of collection by the collection engine 208. The a priori classification engine 220 may classify the data prior to the data being stored in the databases 226. However, in some cases, the data may be stored prior to or simultaneously with the a priori classification engine 220 classifying the data. The data may be classified based on one or more characteristics or pieces of metadata associated with the data. For example, an email may be classified based on the email address, a domain or provider associated with the email, or the recipient of the email.

In addition to, or instead of, using the a priori classification engine 220, the task scheduler 218 may provide the data to the a posteriori classification engine 222 for classification. The a posteriori classification engine 222 may determine trends associated with the collected data. The a posteriori classification engine 222 may classify data after the data has been collected and stored in the databases 226. However, in some cases, the a posteriori classification engine 222 may be used to classify data immediately after the data is collected by the collection engine 208. Data may be processed and classified or reclassified multiple times by the a posteriori classification engine 222. In some cases, the classification and reclassification of the data may occur on a continuing basis, e.g., over time. In other cases, the classification and reclassification of data may occur at specific times. For example, data may be reclassified each day at midnight, once a week, or the like. As another example, data may be reclassified each time one or more of the engines 220, 222 is modified or after the collection of new data.

In some cases, the a posteriori classification engine 222 may classify data based on one or more probabilistic algorithms based on a type of statistical analysis of the collected data. For example, the probabilistic algorithms may be based on Bayesian analysis or probabilities. Further, Bayesian inferences may be used to update the probability estimates calculated by the a posteriori classification engine 222. In some implementations, the a posteriori classification engine 222 may use machine learning techniques to optimize or update the a posteriori algorithms. In some embodiments, some of the a posteriori algorithms may determine the probability that particular data (e.g., an email) should have a particular classification based on an analysis of the data as a whole. Alternatively, or in addition, some of the a posteriori algorithms may determine the probability that particular data should have a particular classification based on the combination of probabilistic determinations associated with subsets of the data, parameters, or metadata associated with the data (e.g., classifications associated with the content of the email, the recipient of the email, the sender of the email, etc.).

For example, in the email example, one probabilistic algorithm may be based on the combination of the classification or determination of four characteristics associated with the email, which may be used to determine whether to classify the email as a personal email, or non-work related. The first characteristic may include the probability that an email address associated with a participant (e.g., sender, recipient, BCC recipient, etc.) of the email conversation is used by a single employee. This determination may be based on the email address itself (e.g., topic based versus name based email address), the creator of the email address, or any other factor that may be used to determine whether an email address is shared or associated with a particular individual. The second characteristic may include the probability that keywords within the email are not associated with peer-to-peer or work-related communications. For example, terms of endearment and discussion of children and children's activities are less likely to be included in work related communications. The third characteristic may include the probability that the email address is associated with a participant domain or a public service provider (e.g., Yahoo® email or Google® email) as opposed to a corporate or work email account. The fourth characteristic may include determining the probability that the message or email thread may be classified as conversational as opposed to, for example, formal. For example, a series of quick questions in a thread of emails, the use of a number of slang words, or excessive typographical errors may indicate that an email is likely conversational. In this example, the a posteriori classification engine 222 may use the probabilities of the above four characteristics to determine the probability that the email communication is personal, work-related, or spam.

The combination of probabilities may not total 100%. Further, the combination may itself be a probability and the classification may be based on a threshold determination. For example, the threshold may be set such that an email is classified as personal if there is a 90% probability for three of the four above parameters indicating the email is personal (e.g., email address is used by a single employee, the keywords are not typical of peer-to-peer communication, at least some of the participant domains are from known public service providers, and the message thread is conversational).

As another example of the a posteriori classification engine 222 classifying data, the a posteriori classification engine 222 may use a probabilistic algorithm to determine whether a participant of an email is a customer. The a posteriori classification engine 222 may use the participant's identity (e.g., a customer) to facilitate classifying data that is associated with the participant (e.g., emails, files, etc.). To determine whether the participant should be classified as a customer, the a posteriori classification engine 222 may examine a number of parameters, such as a relevant Active Directory Organizational Unit (e.g., sales, support, finance, or the like) associated with the participant and/or other participants in communication with the participant, the participant's presence in forum discussions, etc. In some cases, characteristics used to classify data may be weighted differently as part of the probabilistic algorithm. For example, email domain may be a poor characteristic to classify a participant in some cases because the email domain may be associated with multiple roles. For instance, Microsoft® may be a partner, a customer, and a competitor.

In some implementations, a user (e.g., an administrator) may define the probabilistic algorithms used by the a posteriori classification engine 222. For example, if customer Y is a customer of business X, the management of business X may be interested in tracking the percentage of communication between business X and customer Y that relates to sales. Further, suppose that a number of employees from business X and a number of employees from business Y are in communication via email. Some of these employees may be in communication to discuss sales. However, it is also possible that some of the employees may be in communication for technical support issues, invoicing, or for personal reasons (e.g., a spouse of a business X employee may work at customer Y). Thus, in this example, to track the percentage of communication between business X and customer Y that relates to sales the user may define a probabilistic algorithm that classifies communications based on the probability that the communication relates to sales. The algorithm for determining the probability may be based on a number of pieces of metadata associated with each communication. For example, the metadata may include the sender's job title, the recipient's job title, the name of the sender, the name of the recipient, whether the communication identifies a product number or an order number, the time of communication, a set of keywords in the content of the communication, etc.

Using the a posteriori classification engine 222, data may be classified based on metadata associated with the data. For example, the communication in the above example may be classified based on whether it relates to sales, supplies, project development, management, personnel, or is personal. The determination of what the data relates to may be based on any criteria. For example, the determination may be based on keywords associated with the data, the data owner, the data author, the identity or roles of users who have accessed the data, the type of data file, the size of the file, the data the file was created, etc.

In certain embodiments, the a posteriori classification engine 222 may use the heuristics engine 224 to facilitate classifying data. Further, in some cases, the a posteriori classification engine 222 may use the heuristics engine 224 to validate classifications, to develop probable associations between potentially related content, and to validate the associations as the data collection system 202 collects more data. In certain embodiments, the a posteriori classification engine 222 may base the classifications of data on the associations between potentially related content. In some implementations, the heuristic engine 224 may use machine learning techniques to optimize or update the heuristic algorithms.

In some embodiments, a user (e.g., an administrator) may verify whether the data or metadata has been correctly classified. Based on the result of this verification, in some cases, the a posteriori classification engine 222 may correct or update one or more classifications of previously processed or classified data. Further, in some implementations, the user may verify whether two or more pieces of data or metadata have been correctly associated with each other. Based on the result of this verification, the a posteriori classification engine 222 using, for example, the heuristics engine 224 may correct one or more associations between previously processed data or metadata. Further, in certain embodiments, one or more of the a posteriori classification engine 222 and the heuristics engine 224 may update one or more algorithms used for processing the data provided by the data collection system 202 based on the verifications provided by the user.

In some embodiments, the heuristics engine 224 may be used as a separate classification engine from the a priori classification engine 220 and the a posteriori classification engine 222. Alternatively, the heuristics engine 224 may be used in concert with one or more of the a priori classification engine 220 and the a posteriori classification engine 222. Similar to the a posteriori classification engine 222, the heuristics engine 224 generally classifies data after the data has been collected and stored at the databases 226. However, in some cases, the heuristics engine 224 may also be used to classify data immediately after the data is collected by the collection engine.

The heuristics engine 224 may use a heuristic algorithm for classifying data. For example, the heuristics engine 224 may determine one or more characteristics associated with the data and classify the data based on the characteristics. For example, data that mentions a product, includes price information, addresses (e.g., billing and shipping addresses), and quantity information may be classified as sales data. In some cases, the heuristics engine 224 may classify data based on a subset of the characteristics. For example, if a majority or two-thirds of characteristics associated with a particular classification are identified as existing in a set of data, the heuristics engine 224 may associate the classification with the set of data. In some cases, the heuristics engine 224 may determine whether one or more characteristics are associated with the data. Alternatively, or in addition, the heuristics engine 224 may determine the value or attribute of a particular characteristic associated with the data. The value or attribute of the characteristic may then be used to determine a classification for the data. For example, one characteristic that may be used to classify data is the length of the data. For instance, in some cases, a long email may make one classification more likely than a short email.

The a priori classification engine 220 and the a posteriori classification engine 222 may store the data classification in the databases 226. Further, the a posteriori classification engine 222 and the heuristics engine 224 may store the probable associations between potentially related data at the databases 226. In some cases, as classifications and associations are updated based on, for example, user verifications or updates to the a posteriori and heuristic classification and association algorithms, the data or metadata stored in the databases 226 may be modified to reflect the updates.

Users may communicate with the SME system 102 using a client computing device. In some cases, access to the SME system 102, or to some features of the SME system 102, may be restricted to users who are using specific client devices. In some cases, a user may access the SME system 102 to verify classifications and associations of data by the data classification system 204. In addition, in some cases, at least some users may access at least some of the data and/or metadata stored at the data classification system 204 using the access system 206. The access system 206 may include a user interface 228, a query manager 230, and a query security manager 232.

The user interface 228 may enable a user to query and display the data gathered and stored by the SME system 102. For example, the user interface 228 may enable the user to submit a query to the SME system 102 to access the data or metadata stored at the databases 226. The query may be based on any number of or type of data or metadata fields or variables. By enabling a user to create a query based on multiple type of fields, the user may create complex queries. Further, because the SME system 102 may collect and analyze data from a number of internal and external data sources, a user of the SME system 102 may extract data that is not typically available by accessing a single data source. For example, a user may query the SME system 102 to locate all personal messages sent by the members of the user's department within the last month. As a second example, a user may query the SME system 102 to locate all helpdesk requests received in a specific month outside of business hours that were sent by customers from Europe. As an additional example, a product manager may create a query to examine customer reactions to a new product release or the pitfalls associated with a new marketing campaign. The query may return data that is based on a number of sources including, for example, emails received from customers or users, Facebook® posts, Twitter® feeds, forum posts, quantity of returned products, etc.

Further, in some cases, a user may create a relatively simple query to obtain a high-level view of an organization's knowledge compared to systems that are incapable of integrating the potentially large number of information sources used by some businesses or organizations. For example, a user may query the SME system 102 for information associated with customer X over a time period. In response, the SME system 102 may provide the user with information associated with customer X over the time period, which may include who communicated with customer X, the percentage of communications relating to specific topics (e.g., sales, support, etc.), the products designed for customer X, the employees who performed any work relating to customer X and the employees' roles, etc. The information provided in response to the user's query may not be provided by a single data source but rather by multiple data sources. For example, the communications may be obtained from an email server, the products may be identified from product drawings, and the employees and their roles may be identified by examining who accessed specific files in combination with the employees' human resources (HR) records.

The query manager 230 may enable the user to create and submit a query. The query manager 230 may present the available types of search parameters for searching the databases 226 to a user via the user interface 228. The search parameter types may include different types of search parameters that may be used to form a query for searching the databases 226. For example, the search parameter types may include names (e.g., employee names, customer names, vendor names, etc.), data categories (e.g., sales, invoices, communications, designs, miscellaneous, etc.), stored data types (e.g., strings, integers, dates, times, etc.), data sources (e.g., internal data sources, external data sources, communication sources, sales department sources, product design sources, etc.), dates, etc. In some cases, the query manager 230 may also parse a query provided by a user. In some cases, some queries may be provided using a text-based interface or using a text-field in a Graphical User Interface (GUI). In such cases, the query manager 230 may be configured to parse the query.

Further, the query manager 230 may cause any type of additional options for querying the databases 226 to be presented to the user via the user interface 228. These additional options may include, for example, options relating to how query results are displayed or stored.

In some cases, access to the data stored in the SME system 102 may be limited to specific users or specific roles. For example, access to the data may be limited to “John Smith” or to senior managers. Further, some data may be accessible by some users, but not others. For example, sales managers may be limited to accessing information relating to sales, invoicing, and marketing, technical managers may be limited to accessing information relating to product development, design and manufacture, and executive officers may have access to both types of data, and possibly more. In certain embodiments, the query manager 230 may limit the search parameter options that are presented to a user for forming a query based on the user's identity and/or role.

The query security manager 232 may include any system for regulating who may access the data or subsets of data. The query security manager 232 may regulate access to the databases 226 and/or a subset of the information stored at the databases 226 based on any number and/or types of factors. For example, these factors may include a user's identity, a user's role, a source of the data, a time associated with the data (e.g., the time the data was created, a time the data was last accessed, an expiration time, etc.), whether the data is historical or current, etc.

Further, the query manager security 232 may regulate access to the databases 226 and/or a subset of the information stored at the databases 226 based on security restrictions or data access policies implemented by the business logic security manager 214. For example, the business logic security manager 214 may identify data that is “sensitive” based on a set of rules, such as whether the data mentions one or more keywords relating to an unannounced product in development. The business logic security manager 214 may label the sensitive data as sensitive and may identify which users or roles, which are associated with a set of users, may access data labeled as sensitive. The query security manager 232 may regulate access to the data labeled as sensitive based on the user or the role associated with the user who is accessing the databases 226.

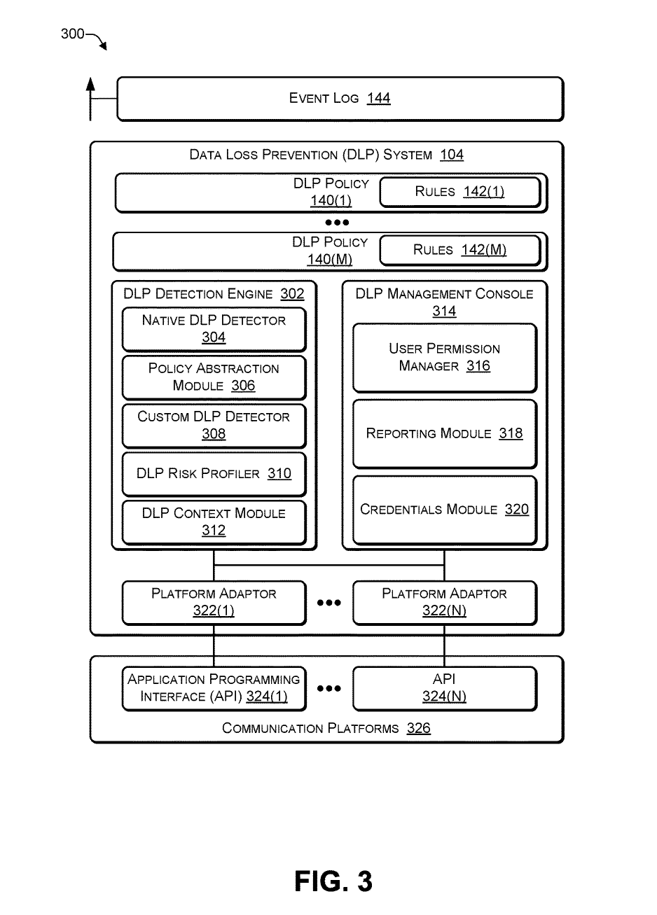

FIG. 3 is a block diagram of an architecture 300 that includes the data loss prevention (DLP) system 104 of FIG. 1 according to some embodiments. The DLP system 104 includes a DLP detection engine 302 and a DLP management console 314. The DLP detection engine 302 may perform operations that create and activate the DLP policies 140. The DLP detection engine 302 may monitor employee communications in an enterprise to identify violations of the DLP policies 140.

The DLP management console 314 may generate the event log 144 in response to determining that one or more of the DLP policies 140 have been violated. The DLP detection engine 302 and the DLP management console 314 may communicate with multiple communication platforms 326. The communications platforms 326 are representative of the enterprise data sources 120 and the external data sources 130 as illustrated in FIG. 1. For ease of illustration and description, the enterprise data sources 120 and the external data sources 130 are shown collectively as the communications platforms 326. Each of the communications platforms 326 may include an application programming interface (API) 324(1) to 324(N) (N>1). The APIs 324 may each be a logical encapsulation of functions and operations provided by each of the communications platforms 326. Such functions and operations may be exposed via a plurality of native APIs and/or access interfaces corresponding to each of the communications platforms 326, rather than via a common API. Some or all of the communications platforms may not provide an API. Each of the APIs 324 provides an interface to enable native DLP support for the communications platforms 326. Examples of native DLP support that can be provided by individual communications platforms 326 include specifying a native DLP policy in a structure and format understood by the individual communications platforms, activating a native DLP policy, implementing enforcement actions allowed by that communications platform (e.g., placing restrictions on a user or group of users), and/or the like.

The APIs 324 may not provide homogenous functionality. For example, the DLP system 104 may provide a common interface into the APIs 324 via platform adaptors 322(1) to 322(N). Each of the platform adaptors 322 may map a standard set of functionality to corresponding sets of calls to the APIs 324. In this way, the platform adaptors 322 can be collectively considered a standard API that is operable to be called, for example, by components of the DLP detection engine 302 and the DLP management console 314. The standard API of the platform adaptors 322 can include, for example, functions that specify a native DLP policy on a given communications platform, functions that activate a native DLP policy, functions that implement specific enforcement actions, etc.

The DLP detection engine 302 includes a native DLP detector 304, a policy abstraction module 306, a custom DLP detector 308, a DLP risk profiler 310, and a DLP context module 312. The policy abstraction module 306 provides an interface for a user such as, for example, an administrator, to create and/or activate DLP policies. The policy abstraction module 306 typically creates the DLP policies in a standardized policy format. The standardized policy format may be any format for specifying rules and/or Boolean conditions. In some cases, the standardized policy format may correspond to a format natively supported by one or more of the communications platforms 326. In a typical embodiment, how the DLP policies are activated on the communications platforms 326 can depend on, among other things, an extent to which each of the communications platforms 326 provides DLP support, administrator preference, etc. In many cases, some or all of the communications platforms 326 may provide at least some native DLP support. In these cases, if it is desired to activate a given DLP policy natively on the communications platforms 326, the policy abstraction module 306 can provide the given DLP policy in a corresponding call to the platform adaptors 322. The platform adaptors 322 may receive a particular one of the DLP policies 140 in a standardized policy format and translate the policy into a respective native format used by each of the communications platforms 326. If an individual one of the communications platforms 326 has a pre-existing native DLP policy that is equivalent to a standardlized DLP policy, instead of creating a native DLP policy, a corresponding platform adaptor of the platform adaptors 322 may specify the equivalent native DLP policy. After a particular DLP policy has been created and/or natively activated, as appropriate, the native DLP detector 304 can perform DLP detection.

As mentioned above, at least some of the communications platforms 326 may either provide no DLP support or provide DLP support that is insufficient in some respect for natively activating the given DLP policy. In addition, even if sufficient DLP support is provided by the communications platforms 326, the administrator for the DLP system 104 may desire to centrally activate a particular DLP policy for a particular set of communications platforms of the communications platforms 326. Central activation means that, with the communications platforms 326, policy violation detection is performed centrally by the DLP system 104 without relying on native DLP functionality, of the communications platforms 326.

The policy abstraction module 306 may provide a particular DLP policy to the custom DLP detector 308 for storage and implementation. The policy abstraction module 306 may maintain the DLP policies 140 in a central location, such as, for example, in a database, persistent file-based storage, or the like. The policy abstraction module 306 may track how each DLP policy is activated on each of the communications platforms 326. As described above, DLP policies can be activated natively on the communications platforms 326, centrally activated by the DLP system 104, or a combination thereof. The manner of activation may be maintained by the policy abstraction module 306 as part of its tracking functionality. The native DLP detector 304 may manage policy violation detection for native activations of DLP policies. The native DLP detector 304 may import policy violations of native DLP policies, for example, from logs that are generated by each of the communication platforms 326. In some cases, the logs can be accessed via, for example, the platform adaptors 322 and the APIs 324. In other cases, it may be possible to access such logs without the platform adaptors 322 and/or the APIs 324, e.g., by using a network storage location of the logs. The custom DLP detector 308 may manage violation detection for central activations of DLP policies. The custom DLP detector 308 may perform violation detection on communications (e.g., emails, voicemails, instant messages, etc.) that have been centrally collected and stored. In this fashion, with respect to the central activations, the DLP policy can be applied and evaluated against such communications for purposes of identifying violations.

The DLP risk profiler 310 may determine that a policy has been violated or quasi-violated. In response, the DLP risk profiler 310 may generate the event log 144. A quasi-violation refers to user activity or behavior that does not violate a given policy but that is measurably (based on configurable parameters) close to violating the given policy. An actual violation refers to user activity or behavior that violates one or more of the DLP policies 140. What constitutes measurably close may be defined, for example, via statistical, mathematical, and/or rule-based methods. For example, a particular DLP policy may prohibit sending files (e.g., email attachments) that are larger than a maximum size (e.g., ten megabytes). In this example, measurably close may be defined as being within a certain percentage of the maximum size (e.g., five percent), being within a certain numeric range relative to the maximum size (e.g., greater than nine megabytes but less than ten megabytes), etc. Measurably close may be further defined to include a repetition factor. For example, quasi-violations may occur where a user has met the above definition at least a specified number of times (e.g., five) within a specified window of time (e.g., one hour, one day, one week, etc.). Quasi-violations may be limited to cases where the number of times that the user has sent such files is within a certain number of standard deviations of an expected value for the specified window of time. It should be appreciated that similar principles may be applied to automatically identify quasi-violations for other types of DLP policies that specify, for example, values and/or thresholds.

The DLP risk profiler 310 may trigger a quasi-violation based on, for example, an assessment that a DLP policy is in imminent risk of being violated. For example, certain DLP policies may relate to values that tend to increase over time or that exhibit a pattern (e.g., linear or exponential). For example, a particular DLP policy may limit each user to a certain quantity of instant messages per day (e.g., 100). If it appears that a particular user is projected to reach the specified quantity (e.g., based on a linear trend) or is within a defined range of the certain quantity (e.g., ninety-five instant messages before 2:00 pm local time), a quasi-violation could be triggered. A quasi-violation could also be triggered if, for example, a characteristic precursor to an actual violation has been detected. For example, a particular DLP policy could specify that communications to customer A cannot occur via email. In that case, a characteristic precursor to an actual violation could be the appearance in a user's email contacts of an email address specifying Customer A's domain (e.g., someone@CustomerA.com).

The DLP risk profiler 310 may perform on-demand risk assessment. For example, designated users (e.g., the experts 152 of FIG. 1), administrators, or the like may use the DLP risk profiler 310 to perform a risk query. In some cases, the risk query may be in a format similar to a DLP policy. For example, the risk query may be phrased similar to a prospective DLP policy. An administrator, for example, may use the risk query to search communications that have been collected to determine a business impact of implementing the DLP policy. The risk query may be tailored to identify information related to the business impact. After execution of the risk query, the information is returned to the administrator. Based on the information returned by the risk query, the administrator may determine how many users exhibit behaviors that would be prohibited by the prospective DLP policy (e.g., the query), an overall number of past communications within a certain period of time that would have been implicated by the prospective DLP policy, which departments or organizational units would be most impacted by the prospective DLP policy, etc.

The DLP context module 312 may dynamically acquire context information in response to determining a policy violation. In various embodiments, what constitutes context information for a violation of a particular DLP policy may be predefined (e.g., as a query). Responsive to a violation of the particular DLP policy, the query may be executed to yield the context information. In some embodiments, at least a portion of what constitutes context information may be specified, for example, by designated users upon receipt of an alert. In such embodiments, the designated users (e.g., the experts 152 of FIG. 1) may request particular data points that are of interest given the contents of the alert. The context information may be acquired from any of the communications platforms 326. For example, if a user violates the DLP policy of an email platform, the context information could include information related to the user's contemporaneous communications on each of an instant-messaging platform, an enterprise social-networking platform, and/or any of the communications platforms 326.

The DLP management console 314 includes a user permission manager 316, a reporting module 318, and a credentials module 320. The user permission manager 316 may maintain an access profile for each user of the DLP system 104. The access profile can be created based on, for example, directory information (e.g., Active Directory). In some embodiments, the access profile can be created by an administrator. The access profile typically specifies a scope of violations that the user is authorized to view and/or for which the user should receive alerts or reports (e.g., all staff, all employees beneath the user in an employee hierarchy, etc.). The access profile may specify enforcement actions that the user is allowed to take if, for example, DLP violations have occurred. In some cases, the user's ability to take the enforcement action may be conditioned on a policy violation(s) having occurred. In other cases, some or all of the enforcement actions may be available to the user unconditionally. A user may be considered a designated user with respect to those DLP policies for which the user is authorized to view violations, receive reports or alerts on violations, and/or take enforcement actions.

The reporting module 318 provides an interface to display to designated users (e.g., the experts 152 of FIG. 1) information pertaining to violations of DLP policies and associated context information. The reporting module 318 may generate alerts (e.g., the alert 150) and/or reports using, for example, any of the communications platforms 326. The reports and/or alerts can be communicated using, for example, SMS text message, email, instant message, a dashboard interface, social media messages, web pages, etc. The reporting module 318 may provide a user interface displaying enforcement actions that each designated user (e.g., one of the experts 152 of FIG. 1) is authorized to take in response to the alert. The enforcement actions can include, for example, blocking particular domains (e.g., example.com), suspending a user account on all or selected ones of the communications platforms 326, blocking sending communications, blocking receiving communications, and/or the like. In some embodiments, the enforcement actions, can include a “suspend” option that suspends a user or group of users' access to all of the communications platforms 326. The credentials module 320 may store administrative credentials for accessing each of the communications platforms 326 via, for example, the APIs 324. The credentials module 320 may enable designated users (e.g., the experts 152 of FIG. 1) to execute administrative actions (e.g., enforcement actions) that the designated users would ordinarily lack permission to perform, thereby saving time and resources of system administrators. The user permission manager 316 can determine, via access profiles, enforcement actions that the designated users are authorized to perform. Responsive to selections by the designated users, the credentials module 320 can execute those enforcement actions on the communications platforms 326 using the stored administrative credentials.

Thus, the DLP system 104 may monitor employee communications in an enterprise across the multiple communication platforms 326. In response to determining that a particular communication violates one of the DLP policies 140, the DLP system 104 may generate the event log 144.

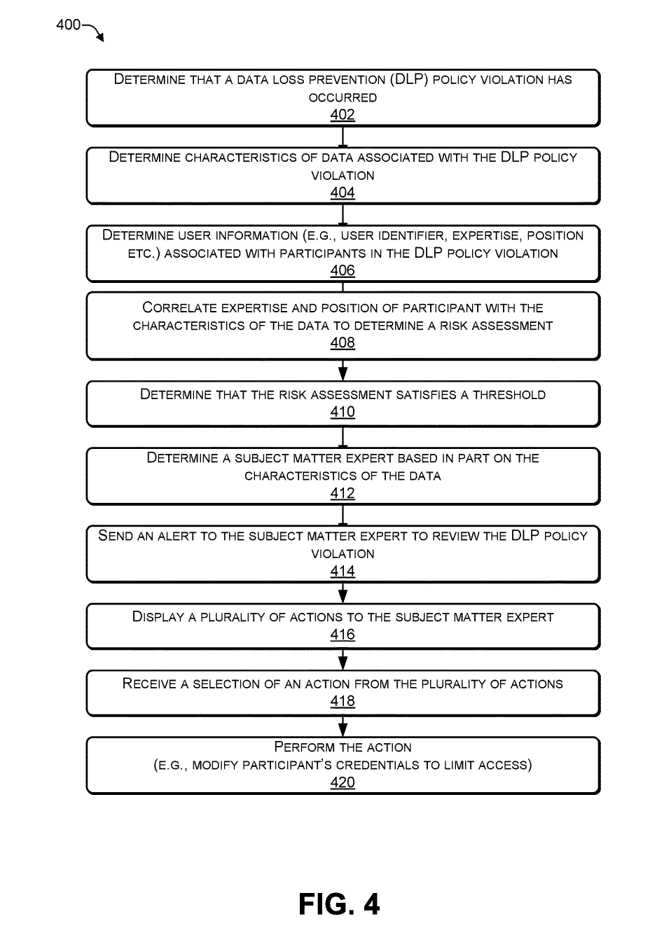

In the flow diagram of FIG. 4, each block represents one or more operations that may be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations may be combined in any order and/or in parallel to implement the processes. For discussion purposes, the process 400 is described with reference to FIG. 1, 2, or 3 as described above, although other models, frameworks, systems and environments may implement these processes.

FIG. 4 is a flowchart of a process 400 that includes determining that a risk assessment satisfies a threshold according to some embodiments. The process 400 may be performed by one or more of the SME system 102, the DLP system 104, or the risk assessment engine 106.

At 402, a determination may be made that a DLP policy violation has occurred. At 404, characteristics of data associated with the DLP policy violation may be determined. At 406, user information associated with each of the participants in the DLP policy violation may be determined. At 408, the expertise and position of each participant may be correlated with the characteristics of the data to determine a risk assessment for the DLP policy violation. For example, in FIG. 1, the DLP system 104 may monitor the enterprise data sources 120 (including the communication systems 122 and the collaboration systems 126). In response to determining that an event has occurred that violated one or more of the DLP policies 140, the DLP system 104 may generate an event log 144. The risk assessment engine 106 may analyze the event log 144 to identify characteristics of the data involved in the DLP policy violation and user information associated with each of the participants in the DLP policy violation. The characteristics may include a classification associated with the data (e.g., whether the data is classified as public, internal, confidential, or restricted), a topic (e.g., technology area, such as cloud computing, or an area, such as marketing) associated with the data, and a privilege level (e.g., the type of credentials or privileges) to access the data. For example, certain documents may only be accessible to users having a particular access privilege level. The SME system 102 may maintain employee profiles 116 based on data gathered from the enterprise data sources 120 and the external data sources 130. The employee profiles 116 may include information relating to each employee's depth of expertise and breadth of expertise and each employee's position (e.g., title and position in a hierarchical organization structure) in the enterprise. The user information may include the SME assessments 148 associated with the participants (e.g., sender and recipients) in the event. The risk assessment engine 106 may correlate the expertise and position of each participant with the characteristics of the data to determine a risk assessment for the DLP policy violation. For example, the risk assessment may be high, medium, or low, or a number within a numeric range.

At 410, a determination may be made that the risk assessment satisfies a threshold. At 412, a subject matter expert may be determined based in part on the characteristics of the data. At 414, an alert may be sent to the subject matter expert requesting review of the DLP policy violation. For example, in FIG. 1, if the risk assessment engine 106 determines that the risk assessment satisfies a threshold (e.g., risk assessment is high), then the risk assessment engine 106 may determine a subject matter expert (e.g., one of the experts 152) from the SME list 149 based on the characteristics of the data. For example, if a document that is related to a particular topic, e.g., the company's cloud-computing strategy, was emailed to an external party, the risk assessment engine 106 may identify the experts 152 from the SME list 149 who are experts in the particular topic, e.g., cloud-computing. For example, an expert may be a member of a team involved in setting the company's cloud-computing strategy. After identifying the experts 152 from the SME list 149, the risk assessment engine 106 may send the alert 150 to the experts 152 requesting that they review the DLP policy violation. The alert 150 may include one or more of the event log 144, the data characteristics, and the SME assessments 148.

At 416, a plurality of actions available to the subject matter expect may be displayed (e.g., in a user interface). At 418, a selection of an action may be received from the plurality of actions. At 420, the action may be performed, e.g., to prevent the participant from performing another DLP policy violation. For example, in FIG. 3, the DLP management console 314 may present a user interface that includes multiple actions from which an expert may select. For example, if the expert determines that an event in which there is high risk that data loss occurred or is about to occur, the expert may select an action from multiple options to try to minimize further data loss. For example, the action selected by the expert may cause the credentials of one or more participants associated with the event to be revoked, locking them out of all enterprise systems, and preventing them from accessing any additional data. In this way, the expert may select an action that prevents the participants from performing another DLP policy violation.

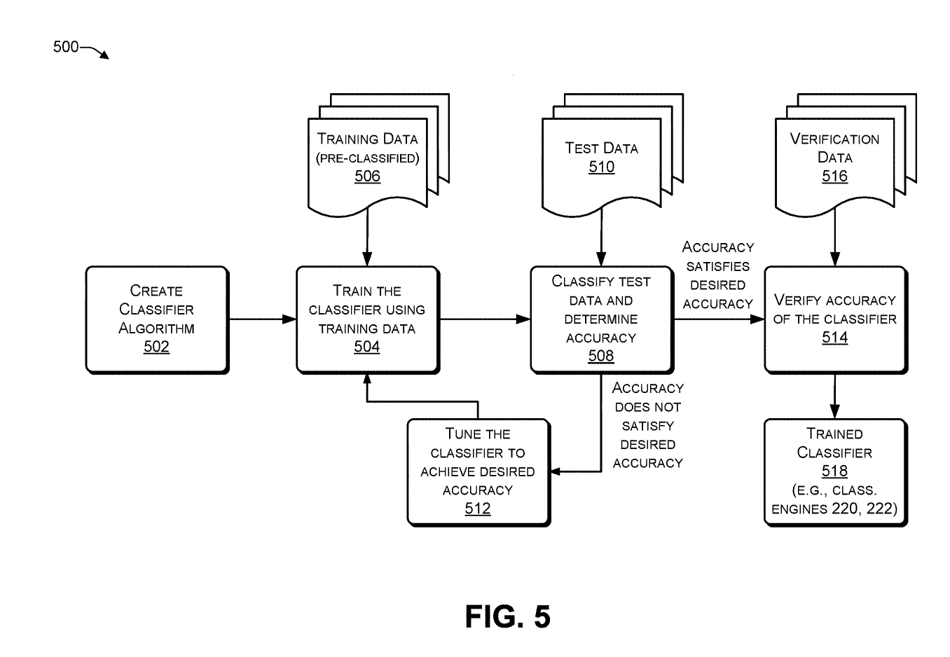

FIG. 5 illustrates an exemplary process 500 to create (e.g., build and train) a classifier, e.g., the risk assessment engine 106 of FIG. 1, or the classification engines 220, 222 of FIG. 2.

At 502, the classifier algorithm is created. For example, software instructions that implement one or more algorithms may be written to create the classifier. The algorithms may implement machine learning, pattern recognition, and other types of algorithms, using techniques such as a support vector machine, decision trees, ensembles (e.g., random forest), linear regression, Bayesian, neural networks, logistic regression, perceptron, or other machine learning algorithm.

At 504, the classifier may be trained using training data 506. The training data 506 may include external documents and internal documents whose keywords have been pre-classified by a human, e.g., an expert. The external documents may include documents such as patent applications, technical papers, and the like, and the internal documents may include documents such as PowerPoint® documents, Word® documents, emails, and the like.

At 508, the classifier may be instructed to classify test data 510. The test data 510 (e.g., keywords in documents) may have been pre-classified by a human, by another classifier, or a combination thereof An accuracy with which the classifier has classified the test data 510 may be determined. If the accuracy does not satisfy a desired accuracy, at 512 the classifier may be tuned to achieve a desired accuracy. The desired accuracy may be a predetermined threshold, such as ninety-percent, ninety-five percent, ninety-nine percent and the like. For example, if the classifier was eighty-percent accurate in classifying the test data and the desired accuracy is ninety-percent, then the classifier may be further tuned by modifying the algorithms based on the results of classifying the test data 510. 504 and 512 may be repeated (e.g., iteratively) until the accuracy of the classifier satisfies the desired accuracy.

When the accuracy of the classifier in classifying the keywords in the test data 510 satisfies the desired accuracy, at 508, the process may proceed to 514 where the accuracy of the classifier may be verified using verification data 516 (e.g., internal and external documents). The verification data 516 may have include keywords pre-classified by a human, by another classifier, or a combination thereof. The verification process may be performed at 514 to determine whether the classifier exhibits any bias towards the training data 506 and/or the test data 510. The verification data 516 may be data that are different from both the test data 510 and the training data 506. After verifying, at 514, that the accuracy of the classifier satisfies the desired accuracy, the classifier 518 may be used to classify keywords in internal documents and external documents. For example, the classifier 518 may identify technical keywords (e.g., “security”) and technical phrases (e.g., “cloud computing”) in internal and external documents associated with each employee to determine the subject matter expertise of each employee. The classifier 518 may be used to analyze event logs and data loss events to correlate which event logs are associated with data loss events to assess the risk associated with an event log (e.g., the event log 144 of FIG. 1). The classifier 518 may be used to analyze data loss events and the subject matter expertise of participants. If the accuracy of the classifier does not satisfy the desired accuracy, at 514, then the classifier may be trained using additional training data, at 504. For example, if the classifier exhibits a bias to the training data 506 and/or the test data 510, the classifier may be training using additional training data to reduce the bias.

Thus, the classifier 518 may be trained using training data and tuned to satisfy a desired accuracy. After the desired accuracy of the classifier 518 has been verified, the classifier 518 may be used, for example, to classify keywords in documents or to determine the risk of data loss associated with documents.

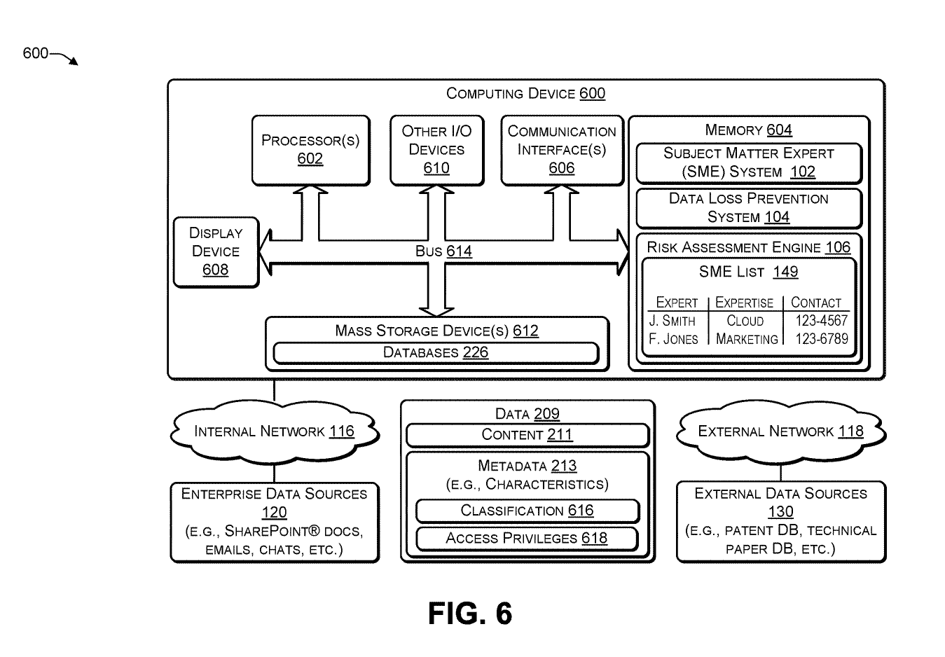

FIG. 6 illustrates an example configuration of a computing device that may be used to implement the systems and techniques described herein, such as to implement the SME system 102, the DLP system 104, or the risk assessment engine 106 as described above. The computing device 600 may include at least one processor 602, a memory 604, communication interfaces 606, a display device 608, other input/output (I/O) devices 610, and one or more mass storage devices 612, configured to communicate with each other, such as via a system bus 614 or other suitable connection.

The processor 602 is a hardware device that may include a single processing unit or a number of processing units, all of which may include single or multiple computing units or multiple cores. The processor 602 may be implemented as one or more microprocessors, microcomputers, microcontrollers, digital signal processors, central processing units, state machines, logic circuitries, and/or any devices that manipulate signals based on operational instructions. Among other capabilities, the processor 602 may be configured to fetch and execute computer-readable instructions stored in the memory 604, mass storage devices 612, or other computer-readable media.

Memory 604 and mass storage devices 612 are examples of computer storage media (e.g., memory storage devices) for storing instructions which are executed by the processor 602 to perform the various functions described above. For example, memory 604 may generally include both volatile memory and non-volatile memory (e.g., RAM, ROM, or the like) devices. Further, mass storage devices 612 may include hard disk drives, solid-state drives, removable media, including external and removable drives, memory cards, flash memory, floppy disks, optical disks (e.g., CD, DVD), a storage array, a network attached storage, a storage area network, or the like. Both memory 604 and mass storage devices 612 may be collectively referred to as memory or computer storage media herein, and may be a media capable of storing computer-readable, processor-executable program instructions as computer program code that may be executed by the processor 602 as a particular machine configured for carrying out the operations and functions described in the implementations herein.

The computing device 600 may also include one or more communication interfaces 606 for exchanging data via the networks 116, 118 with the enterprise data sources 120 and the external data sources 130, respectively. The communication interfaces 606 may facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, cellular, satellite, etc.), and the like. Communication interfaces 606 may also provide communication with external storage (not shown), such as in a storage array, network attached storage, storage area network, or the like. A display device 608, such as a monitor may be included in some implementations for displaying information and images to users. Other I/O devices 610 may be devices that receive various inputs from a user and provide various outputs to the user, and may include a keyboard, a remote controller, a mouse, a printer, audio input/output devices, and so forth.

The computer storage media, such as memory 604 and mass storage devices 612, may be used to store software and data. For example, the computer storage media may be used to store applications, such as the SME system 102, the DLP system 104, and the risk assessment engine 106. The computer storage media may be used to store data, such as the employee profiles, the databases 226, and other data.

The representative data 209 may be associated with an event log (e.g., the event log 144 of FIG. 1). For example, the data 209 may be a document that is sent as an attachment via email by an employee of the enterprise to one or more external recipients. The data 209 may include the content 211 associated with the data 209 and the metadata 213 associated with the data 209. A topic associated with the data 209 may be determined based on the content 211. For example, the topic may be a word or phrase that occurs in the content 211 with a high frequency. In some cases, the topic may be derived from a particular portion of the content 211, such as a title, a summary, an abstract, etc. of the content 211. The metadata 213 may include various characteristics associated with the data 209, such as a classification 616 and access privileges 618.

An example of a four category taxonomy to classify documents (e.g., based on their contents) may include the classifications public, internal, confidential, or restricted. Documents classified as public may include documents that may be shared with people inside as well as outside of an enterprise (e.g., a company). Documents classified as internal may include documents that may be shared with people inside the enterprise but may not be shared outside the enterprise. Documents classified as confidential may include documents that might harm the enterprise if they were available to unauthorized parties. Documents classified as restricted may include documents that are subject to legal or contractual obligations. Thus, the classification 616 may include one public, internal, confidential, or restricted.

The access privileges 618 may identify the level or type of access privileges used to access the data 209. For example, a first set of users having the privileges specified by the access privileges 618 may access the data 209 while a second set of users lacking the privileges specified by the access privileges 618 may be incapable of accessing the data 209. In some cases, the access privileges 618 may specify that a first set of users have read/write access to the data 209, a second set of users have read only privileges to the data 209, and a third set of users do not have access to the data 209.

The example systems and computing devices described herein are merely examples suitable for some implementations and are not intended to suggest any limitation as to the scope of use or functionality of the environments, architectures and frameworks that may implement the processes, components and features described herein. Thus, implementations herein are operational with numerous environments or architectures, and may be implemented in general purpose and special-purpose computing systems, or other devices having processing capability. Generally, any of the functions described with reference to the figures may be implemented using software, hardware (e.g., fixed logic circuitry) or a combination of these implementations. The term “module,” “mechanism” or “component” as used herein generally represents software, hardware, or a combination of software and hardware that may be configured to implement prescribed functions. For instance, in the case of a software implementation, the term “module,” “mechanism” or “component” may represent program code (and/or declarative-type instructions) that performs specified tasks or operations when executed on a processing device or devices (e.g., CPUs or processors). The program code may be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but may extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Software modules include one or more of applications, bytecode, computer programs, executable files, computer-executable instructions, program modules, software code expressed as source code in a high-level programming language such as C, C++, Perl, or other, a low-level programming code such as machine code, etc. An example software module is a basic input/output system (BIOS) file. A software module may include an application programming interface (API), a dynamic-link library (DLL) file, an executable (e.g., .exe) file, firmware, and so forth.

Processes described herein may be illustrated as a collection of blocks in a logical flow graph, which represent a sequence of operations that may be implemented in hardware, software, or a combination thereof. In the context of software, the blocks represent computer-executable instructions that are executable by one or more processors to perform the recited operations. The order in which the operations are described or depicted in the flow graph is not intended to be construed as a limitation. Also, one or more of the described blocks may be omitted without departing from the scope of the present disclosure.

Although various embodiments of the method and apparatus of the present invention have been illustrated herein in the Drawings and described in the Detailed Description, it will be understood that the invention is not limited to the embodiments disclosed, but is capable of numerous rearrangements, modifications and substitutions without departing from the scope of the present disclosure.

What is claimed is:

1. A computer-implemented method, comprising:
determining that a data loss prevention (DLP) policy violation has occurred;
determining one or more characteristics of data associated with the DLP policy violation;
determining user information associated with a participant associated with the DLP policy violation, the user information including a user identifier associated with the participant, an expertise of the participant, and a position of the participant;
correlating the expertise and the position of the participant with the one or more characteristics of the data to create a correlation factor;
determining a risk assessment associated with the DLP policy violation based on the correlation factor;
determining that the risk assessment satisfies a threshold;
determining a subject matter expert based on at least one of the one or more characteristics of the data; and
sending an alert to the subject matter expert to review the DLP policy violation.

2. The computer-implemented method of claim 1, wherein the one or more characteristics of the data include:
a classification comprising one of a public document classification, an internal document classification, a confidential document classification, or a restricted document classification;
a topic associated with the data; and
a privilege level to access the data.

3. The computer-implemented method of claim 1, wherein determining the expertise of the participant associated with the DLP policy violation comprises:
identifying documents associated with the participant, the documents accessible via external data sources and enterprise data sources;
identifying communications associated with the participant; and
analyzing the documents and the communications to determine the expertise of the participant.

4. The computer-implemented method of claim 3, wherein the external data sources include a patent publication database and a technical publication database.

5. The computer-implemented method of claim 1, further comprising:
displaying to the subject matter expert, via a user interface, a plurality of actions;
receiving a selection of an action from the plurality of actions; and
performing the action.

6. The computer-implemented method of claim 5, wherein the action comprises modifying credentials associated with the participant to prevent the participant from performing an additional DLP policy violation.

7. The computer-implemented method of claim 1, wherein the alert includes:
the one or more characteristics of the data associated with the DLP policy violation; and
the expertise and the position of the participant, wherein the position includes a current title of the participant and an indication of a placement of the participant in a hierarchical organization.

8. One or more non-transitory computer-readable media storing instructions that are executable by one or more processors to perform operations comprising:
determining that a data loss prevention (DLP) policy violation has occurred;
determining one or more characteristics of data associated with the DLP policy violation;
determining user information associated with a participant associated with the DLP policy violation;
determining an expertise and a position of the participant;
correlating the expertise and the position of the participant with the one or more characteristics of the data to create a correlation factor;
determining a risk assessment associated with the DLP policy violation based on the correlation factor;
determining that the risk assessment satisfies a threshold;
determining a subject matter expert based on at least one of the one or more characteristics of the data; and
sending an alert to the subject matter expert to review the DLP policy violation.

9. The one or more non-transitory computer-readable media of claim 8, wherein the one or more characteristics of the data include:
a classification characteristic comprising one of a public document classification, an internal document classification, a confidential document classification, or a restricted document classification;
a topic associated with the data; and
a privilege level to access the data.

10. The one or more non-transitory computer-readable media of claim 8, wherein determining the expertise of the participant associated with the DLP policy violation comprises:
identifying documents associated with the participant, the documents accessible via external data sources and enterprise data sources;
identifying communications associated with the participant; and
analyzing the documents and the communications to determine the expertise of the participant.

11. The one or more non-transitory computer-readable media of claim 10, wherein the external data sources include a patent publication database and a technical publication database.

12. The one or more non-transitory computer-readable media of claim 8, the operations further comprising:
displaying to the subject matter expert, via a user interface, a plurality of actions;
receiving a selection of an action from the plurality of actions; and
modifying credentials associated with the participant to prevent the participant from performing an additional DLP policy violation.

13. The one or more non-transitory computer-readable media of claim 8, wherein the alert includes:
the one or more characteristics of the data associated with the DLP policy violation; and
the expertise and the position of the participant, wherein the position includes a current title of the participant and an indication of a placement of the participant in a hierarchical organization.

14. A server, comprising:
one or more processors; and
one or more non-transitory computer-readable media storing instructions that are executable by the one or more processors to perform operations comprising:
determining that a data loss prevention (DLP) policy violation has occurred;
determining one or more characteristics of data associated with the DLP policy violation;
determining user information associated with a participant associated with the DLP policy violation;
determining an expertise and a position of the participant;
correlating the expertise and the position of the participant with the one or more characteristics of the data to create a correlation factor;
determining a risk assessment associated with the DLP policy violation based on the correlation factor;
determining that the risk assessment satisfies a threshold;
determining a subject matter expert based on at least one of the one or more characteristics of the data; and
sending an alert to the subject matter expert to review the DLP policy violation.

15. The server of claim 14, wherein the one or more characteristics of the data include:
a classification characteristic comprising one of a public document classification, an internal document classification, a confidential document classification, or a restricted document classification;
a topic associated with the data; and
a privilege level to access the data.

16. The server of claim 14, wherein determining the expertise of the participant associated with the DLP policy violation comprises:
identifying documents associated with the participant, the documents accessible via external data sources and enterprise data sources;
identifying communications associated with the participant; and
analyzing the documents and the communications to determine the expertise of the participant.

17. The server of claim 16, wherein:
the external data sources include a patent publication database and a technical publication database; and
the enterprise data sources include a directory service, an internal document database, an email service, an instant messaging service, and a conferencing service.

18. The server of claim 14, further comprising:
displaying to the subject matter expert, via a user interface, a plurality of actions;
receiving a selection of an action from the plurality of actions; and
performing the action.

19. The server of claim 18, wherein the action comprises modifying credentials associated with the participant to prevent the participant from performing an additional DLP policy violation.

20. The server of claim 14, wherein the alert includes:
the one or more characteristics of the data associated with the DLP policy violation; and
the expertise and the position of the participant, wherein the position includes a current title of the participant and an indication of a placement of the participant in a hierarchical organization.
